(19) United States
(12) Patent Application Publication
(10) Pub. No.: US 2026/0219103 A1
(43) Pub. Date: Jul. 30, 2026

(54) THERMAL INDEX ESTIMATING SYSTEM

(71) Applicant: National Institute for Environmental Studies, Tsukuba-shi, Ibaraki (JP)

(72) Inventor: Junya TAKAKURA, Ibaraki (JP)

(21) Appl. No.: 19/148,316

(22) PCT Filed: Jan. 29, 2024
(86) PCT No.: PCT/JP2024/002683

§ 371 Date: Jul. 16, 2025

(30) Foreign Application Priority Data
Apr. 25, 2023 (JP) 2023-071600

(51) Int. Cl. G01J 1/02; G01D 11/26; G01D 21/02; G01J 1/04; G01J 1/42; G01K 1/20; G01K 7/42; G01K 17/04

(52) U.S. Cl. CPC G01J 1/0252; G01D 11/26; G01D 21/02; G01J 1/0411; G01J 1/4204; G01K 1/20; G01K 7/427; G01K 17/04

(57) ABSTRACT

A thermal index estimating system includes: a housing that defines an internal space and is provided with a vent hole that communicates between the internal space and an external space of the housing; a temperature measurement unit that is disposed in the housing and measures a temperature of the internal space; a detection unit that detects motion information indicating a motion of the housing; a light quantity measurement unit that measures a light quantity received by the housing; and an estimation unit that estimates a thermal index in the external space based on the temperature of the internal space, the motion information, and the light quantity.

### TECHNICAL FIELD

The present disclosure relates to a thermal index estimating system.

### BACKGROUND ART

Wearable devices that measures a temperature of an external space, which is one of thermal indices, using a temperature sensor disposed in a housing are known. In such wearable devices, a temperature difference may occur between a temperature of an internal space of the housing and the temperature of the external space of the housing due to solar radiation or the like received by the housing. Patent Literature 1 describes a wearable device including a housing that defines an internal space, a temperature sensor disposed in the internal space, and a heat conduction member that is in contact with the temperature sensor and exposed to the outside of the housing.

### CITATION LIST

### Patent Literature

Patent Literature 1: Japanese Unexamined Patent Publication No. 2016-206024

### SUMMARY OF INVENTION

### Technical Problem

In the wearable device described in Patent Literature 1, the heat conduction member functions as a heat conduction path connecting the temperature sensor disposed in the housing and the external space of the housing. As a result, since the temperature difference between the temperature of the internal space of the housing and the temperature of the external space of the housing is reduced, the temperature of the external space of the housing can be accurately measured by the temperature sensor disposed in the housing. However, a complicated structure is required in which one end of the heat conduction member is brought into contact with the temperature sensor and the other end of the heat conduction member is exposed to the external space outside the housing.

The present disclosure provides a thermal index estimating system that estimates a thermal index in an external space with a simple structure.

### Solution to Problem

A thermal index estimating system according to one aspect of the present disclosure includes: a housing that defines an internal space and is provided with a vent hole that communicates between the internal space and an external space of the housing; a temperature measurement unit that is disposed in the housing and measures a temperature of the internal space; a detection unit that detects motion information indicating a motion of the housing; a light quantity measurement unit that measures a light quantity received by the housing; and an estimation unit that estimates a thermal index in the external space based on the temperature of the internal space, the motion information, and the light quantity.

In estimating the thermal index in the external space of the housing using the temperature of the internal space of the housing, it is necessary to consider the temperature difference between the internal space of the housing and the external space of the housing described above. The temperature difference may depend on an amount of air ventilated between the internal space and the external space via the vent hole and the light quantity received by the housing. Furthermore, the amount of ventilated air may depend on the motion of the housing. For example, when the motion of the housing is intense, the amount of ventilated air can increase. In this thermal index estimating system, the thermal index in the external space is estimated based on the temperature of the internal space of the housing, the motion information indicating the motion of the housing, and the light quantity received by the housing. That is, in this thermal index estimating system, in estimating the thermal index in the external space, the motion information of the housing and the light quantity received by the housing, which may affect the temperature difference between the internal space of the housing and the external space of the housing, are considered. Therefore, the thermal index in the external space can be estimated without providing a member functioning as a heat conduction path connecting the internal space of the housing and the external space of the housing. As a result, the thermal index in the external space can be estimated with a simple structure.

In some embodiments, the estimation unit may estimate the thermal index based on time-series data of the temperature of the internal space, time-series data of the motion information, and time-series data of the light quantity. As described above, although the motion information of the housing and the light quantity received by the housing may affect the temperature difference between the internal space of the housing and the external space of the housing, the motion of the housing and the light quantity received by the housing are not immediately reflected in the temperature difference. Therefore, by using the time-series data of the temperature of the internal space, the motion information, and the light quantity, changes in the temperature of the internal space, the motion information, and the light quantity in a certain period are considered. Therefore, an estimation accuracy of the thermal index in the external space can be improved.

In some embodiments, the estimation unit may estimate the thermal index using a statistical regression model configured to receive the temperature of the internal space, the motion information, and the light quantity as input and output the thermal index. In this configuration, the estimation accuracy of the thermal index in the external space can be improved by sufficiently learning the statistical regression model.

In some embodiments, the detection unit may include an inertial sensor. The motion information may include acceleration of the housing. In this configuration, since the acceleration of the housing remarkably reflects the motion of the housing, the estimation accuracy of the thermal index in the external space can be improved.

In some embodiments, the motion information may further include a direction of the acceleration of the housing. The amount of air ventilated between the internal space of the housing and the external space of the housing via the vent hole can further depend on the motion of the housing in a direction in which the vent hole opens. In a configuration in which the motion information includes the direction of the acceleration of the housing, the motion of the housing in the direction in which the vent hole opens can be derived based on the direction of the acceleration. Therefore, by adopting the direction of the acceleration of the housing as the motion information, the estimation accuracy of the thermal index in the external space can be further improved.

In some embodiments, the thermal index estimating system may further include a filter that is provided in the vent hole and removes a foreign matter. In this configuration, it is possible to ensure air permeability in the vent hole and prevent the foreign matter from entering the housing.

In some embodiments, the housing may be provided with another vent hole. The vent hole and the another vent hole may be opened in directions different from each other. When the thermal index in the external space is estimated, an estimation error may occur. The larger the temperature difference between the internal space of the housing and the external space of the housing, the larger the estimation error. In a configuration in which the vent hole and the other vent hole are opened in directions different from each other, air is efficiently circulated between the internal space of the housing and the external space of the housing, so that the temperature difference between the internal space and the external space can be reduced. As a result, the estimation accuracy of the thermal index in the external space can be improved.

In some embodiments, the thermal index estimating system may further include a window that is provided with the housing and transmits light from the external space to the internal space. The light quantity measurement unit may be disposed in the housing. The window may be disposed at a position overlapping the light quantity measurement unit in a plan view. In this configuration, since the light quantity measurement unit can measure the light quantity received by the housing through the window, the temperature measurement unit and the light quantity measurement unit can be housed in the same housing. Therefore, the thermal index in the external space can be estimated with a simpler structure.

In some embodiments, the window may include a concave lens. In this configuration, the light quantity measurement unit can receive light incident from a wider angle range. As a result, a size of the window can be reduced.

In some embodiments, the window may be formed by thinning the housing. In this configuration, since the window and the housing can be integrally formed, the thermal index in the external space can be estimated with a simpler structure.

### Advantageous Effects of Invention

According to the present disclosure, a thermal index in an external space can be estimated with a simple structure.

### BRIEF DESCRIPTION OF DRAWINGS

FIG. 1 is a block diagram showing an example of a functional configuration of a thermal index estimating system according to an embodiment.

FIG. 2 is a perspective view showing an appearance of a measurement device included in the thermal index estimating system shown in FIG. 1.

FIG. 3 is a cross-sectional view taken along line III-III of FIG. 2.

FIG. 4 is a sequence diagram showing a series of operations performed by the thermal index estimating system shown in FIG. 1.

FIG. 5 is a diagram showing a modification of the measurement device shown in FIG. 2.

FIG. 6 is a diagram showing another modification of the measurement device shown in FIG. 2.

FIG. 7 is a diagram showing still another modification of the measurement device shown in FIG. 2.

### DESCRIPTION OF EMBODIMENTS

Hereinafter, embodiments of the present disclosure will be described in detail with reference to the drawings. Note that, in the drawings, the same elements are denoted by the same reference numerals, and redundant description will be omitted. In each drawing, an XYZ coordinate system may be shown. The Y-axis direction is a direction intersecting (here, orthogonal to) the X-axis direction and the Z-axis direction. The Z-axis direction is a direction intersecting (here, orthogonal to) the Y-axis direction and the Z-axis direction. In the present embodiment, the X-axis direction is the left-right direction, the Y-axis direction is the front-rear direction, and the Z-axis direction is the up-down direction. For convenience of description, the terms “front”, “rear”, “upper”, “lower”, “left”, and “right” are used, but are not limited to these directions.

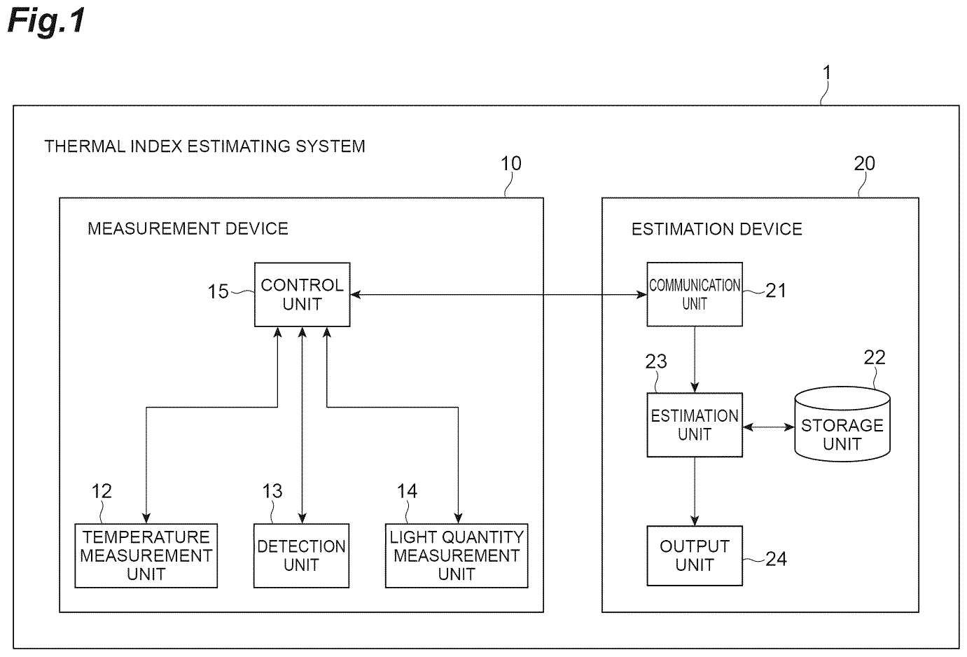

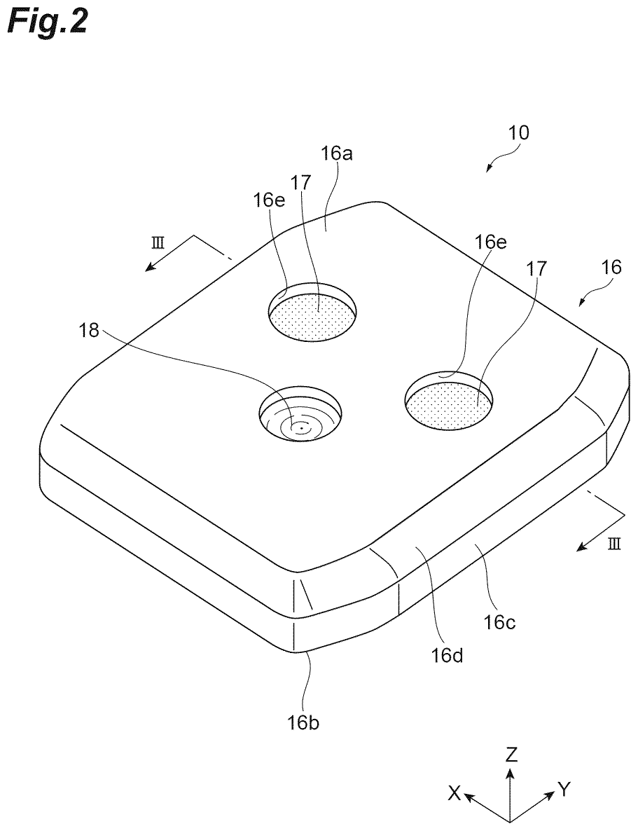

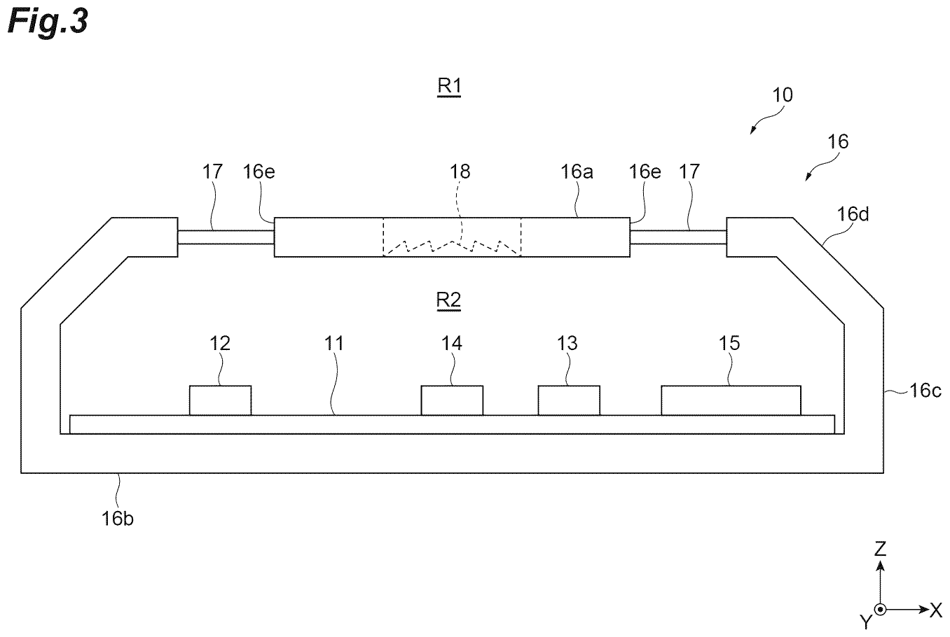

First, a thermal index estimating system according to an embodiment will be described with reference to FIGS. 1 to 3. FIG. 1 is a block diagram showing an example of a functional configuration of the thermal index estimating system according to the embodiment. FIG. 2 is a perspective view showing an appearance of a measurement device included in the thermal index estimating system shown in FIG. 1. FIG. 3 is a cross-sectional view taken along line III-III of FIG. 2. Note that, in FIG. 3, hatching is omitted to clearly show each portion.

A thermal index estimating system 1 shown in FIG. 1 is a system that estimates a thermal index in an external space R1 (see FIG. 3). The external space R1 is, for example, a space located outside a housing 16 (see FIG. 2). The “thermal index” is an index indicating a heat balance of a human body, a feeling of heat or cold, or a risk of heat stroke or the like in a case where a human is present in space. Examples of thermal indices include temperature of an external space, wet bulb globe temperature (WBGT), universal thermal climate index (UTCI), predicted mean vote (PMV), effective temperature (ET), and standard effective temperature (SET). In the present embodiment, the thermal index estimating system 1 estimates the temperature of the external space R1 as the thermal index in the external space R1.

The thermal index estimating system 1 includes a measurement device 10 and an estimation device 20 in order to realize the above-described functions. The measurement device 10 is a device that measures various parameters necessary for estimating the thermal index in the external space R1. The estimation device 20 is a device that estimates the thermal index in the external space R1 using the various parameters measured by the measurement device 10. In the present embodiment, the measurement device 10 and the estimation device 20 are connected to be able to communicate with each other via a communication network (not shown). The communication network may be constituted by either a wired or wireless manner. For example, the communication between the measurement device 10 and the estimation device 20 may be realized by wired communication using a universal serial bus (USB) connection, or may be realized by wireless communication such as Bluetooth (registered trademark) low energy (BLTE). Hereinafter, the measurement device 10 and the estimation device 20 will be described in detail.

First, the measurement device 10 will be described. In the present embodiment, the measurement device 10 measures a parameter necessary for estimating the temperature of the external space R1. The measurement device 10 is a portable device, and examples thereof include a wearable device, a smartphone, and a tablet device. Examples of the wearable device include a device that can be worn on an arm like a smart watch, a device that can be worn on a waist like a pedometer, and a device that can be hung on a neck like a pendant.

As shown in FIGS. 2 and 3, the measurement device 10 includes a circuit board 11, a temperature measurement unit 12, a detection unit 13, a light quantity measurement unit 14, a control unit 15, a housing 16, a filter 17, and a window 18.

The circuit board 11 is a member for electrically connecting the temperature measurement unit 12, the detection unit 13, the light quantity measurement unit 14, and the control unit 15. As shown in FIG. 3, in the present embodiment, the temperature measurement unit 12, the detection unit 13, the light quantity measurement unit 14, and the control unit 15 are mounted on one surface of the circuit board 11, and the circuit board 11 is disposed in the housing 16. A resist may be formed on a surface of the circuit board 11, or silk printing may be applied to the surface of the circuit board 11, for example. In this case, since the surface of the circuit board 11 has glossiness, high reflectance to light can be realized.

The temperature measurement unit 12 is a unit that measures temperature of the internal space R2 defined by the housing 16. In the present embodiment, the temperature measurement unit 12 continuously measures the temperature of the internal space R2. In the present disclosure, “continuously measuring” includes not only continuously measuring but also measuring at predetermined time intervals. The temperature measurement unit 12 outputs the measured temperature of the internal space R2 to the control unit 15.

In the present embodiment, the temperature measurement unit 12 includes a temperature sensor. The temperature sensor is, for example, a semiconductor temperature sensor. The temperature sensor may be a thermistor element, a platinum resistance temperature detector, or a thermocouple.

The detection unit 13 is a unit that detects motion information indicating the motion of the housing 16. The motion information includes acceleration of the housing 16 and a direction of the acceleration. Therefore, the detection unit 13 detects the acceleration of the housing 16 and the direction of the acceleration as the motion information. In the present embodiment, the detection unit 13 continuously detects the motion information of the housing 16. The detection unit 13 outputs the detected motion information of housing 16 to the control unit 15.

In the present embodiment, the detection unit 13 includes an inertial sensor. The inertial sensor is, for example, a micro electro mechanical system (MEMS) type triaxial acceleration sensor. The triaxial acceleration sensor detects accelerations in three directions of the left-right direction, the front-rear direction, and the up-down direction applied to the housing 16. The inertial sensor may be a uniaxial acceleration sensor, a biaxial acceleration sensor, or a six-axis gyro sensor.

The light quantity measurement unit 14 is a unit that measures a light quantity received by the housing 16. The light quantity received by the housing 16 includes, for example, a quantity of solar radiation received by the housing 16. In the present embodiment, the light quantity measurement unit 14 continuously measures the light quantity received by the housing 16. The light quantity measurement unit 14 outputs the measured light quantity to the control unit 15.

In the present embodiment, the light quantity measurement unit 14 includes an optical sensor having sensitivity to light in a visible light region. The optical sensor includes, for example, a photodiode. The light quantity measurement unit 14 may include an optical sensor having sensitivity to light in an ultraviolet region or light in an infrared region. The control unit 15 is a unit that communicates with the estimation device 20 and integrally controls the measurement device 10. As described above, in the present embodiment, the measurement device and the estimation device 20 are connected to be able to communicate with each other via the communication network. Therefore, the control unit 15 communicates with the estimation device 20 via the communication network. The control unit 15 includes, for example, a microcontroller.

The control unit 15 acquires various kinds of estimation time-series data. The estimation time-series data is time-series data used to estimate the temperature of the external space R1. The control unit 15 acquires the estimation time-series data based on a measurement command received from the estimation device 20, and transmits the acquired estimation time-series data to the estimation device 20. Note that a method of acquiring the estimation time-series data and the measurement command will be described later.

The housing 16 is a member for housing the circuit board 11, the temperature measurement unit 12, the detection unit 13, the light quantity measurement unit 14, and the control unit 15. That is, the circuit board 11, the temperature measurement unit 12, the detection unit 13, the light quantity measurement unit 14, and the control unit 15 are disposed in the housing 16. In the present embodiment, in the housing 16, the temperature measurement unit 12, the detection unit 13, the light quantity measurement unit 14, and the control unit 15 are disposed on the circuit board 11. The housing 16 is made of plastic resin and metal.

As shown in FIG. 2, the housing 16 has a flat box shape and defines an internal space R2. In the present embodiment, a corner and a ridge of the housing 16 are chamfered, but the corner and the ridge of the housing 16 may be rounded. Alternatively, the entire housing 16 may be rounded. The housing 16 includes an upper wall portion 16a, a bottom wall portion 16b, a side wall portion 16c, and an inclined wall portion 16d.

The upper wall portion 16a and the bottom wall portion 16b face each other in the up-down direction. The outer shape of the upper wall portion 16a is slightly smaller than the outer shape of the bottom wall portion 16b. The upper wall portion 16a and the bottom wall portion 16b have a square shape in a plan view. The upper wall portion 16a and the bottom wall portion 16b may have a rectangular shape in a plan view.

The side wall portion 16c and the inclined wall portion 16d connect the upper wall portion 16a and the bottom wall portion 16b in the up-down direction. The side wall portion 16c is provided along a peripheral edge of the bottom wall portion 16b to surround the bottom wall portion 16b. The side wall portion 16c is erected on the bottom wall portion 16b, and extends from the bottom wall portion 16b toward the upper wall portion 16a. The inclined wall portion 16d connects a peripheral edge of the upper wall portion 16a and an upper end of the side wall portion 16c. The inclined wall portion 16d is provided along the peripheral edge of the upper wall portion 16a to surround the upper wall portion 16a.

The housing 16 is provided with a vent hole 16e. The vent hole 16e is a through hole that communicates between the internal space R2 and the external space R1. In the present embodiment, the upper wall portion 16a is provided with two vent holes 16e, and each vent hole 16e penetrates the upper wall portion 16a in the up-down direction. The two vent holes 16e are opened in the same direction. In the present embodiment, the two vent holes 16e are open upward.

The filter 17 is a member for removing a foreign matter. Examples of the foreign matter include liquid such as water, dust, and dirt. In the present disclosure, “removing foreign matter” includes not only completely removing foreign matter but also reducing an amount of foreign matter. It can also be said that the filter 17 is a member for preventing the foreign matter from entering the housing 16.

The filter 17 is provided in the vent hole 16e to close the vent hole 16e. Therefore, in the present embodiment, the measurement device 10 includes two filters 17. In the present embodiment, the filter 17 has air permeability and also has a waterproof property and dustproof property in order to realize the above-described functions.

The window 18 is a member that has optical transparency, transmits light received by the housing 16, and causes the light to be incident on the housing 16. The window 18 transmits the light from the external space R1 to the internal space R2. The window 18 is provided with the housing 16. The window 18 is disposed at a position overlapping the light quantity measurement unit 14 in a plan view. The plan view in this case refers to viewing the window 18 in the thickness direction of the window 18. In the present embodiment, the window 18 is provided with the upper wall portion 16a. The window 18 may be formed of a transparent acrylic plate or may be formed by thinning the housing 16.

In the present embodiment, the window 18 includes a concave lens. The concave lens is formed of a transparent resin. As shown in FIG. 3, in the present embodiment, a shape of the concave lens is formed by Fresnel lens. The window 18 only needs to transmit the light received by the housing 16, and the configuration of the window 18 is not limited to the concave lens. The window 18 may be formed of, for example, a simple plate-shape light incident plate.

Next, the estimation device 20 will be described. In the present embodiment, the estimation device 20 estimates the temperature of the external space R1 using the various parameters measured by the measurement device 10.

Although not shown in the figures, the estimation device 20 includes, for example, one or a plurality of computers including a central processing unit (CPU), a random access memory (RAM), a read only memory (ROM), an input device, and an output device. Examples of the input device include a keyboard and a mouse. Examples of the output device include a display. The estimation device 20 implements various functions by, for example, loading a program stored in the ROM into the RAM and executing the program loaded in the RAM by the CPU. As shown in FIG. 1, the estimation device 20 functionally includes a communication unit 21, a storage unit 22, an estimation unit 23, and an output unit 24.

The communication unit 21 is a unit that transmits predetermined information to the measurement device 10 and receives information transmitted from the measurement device 10.

The storage unit 22 is a unit that stores various types of information used or generated in the estimation device 20. In the present embodiment, the storage unit 22 stores various kinds of estimation time-series data, an estimation model, and an estimation result by the estimation unit 23. The estimation model is a statistical regression model for estimating the thermal index of the external space R1. As described above, in the present embodiment, since the estimation device 20 is the device that estimates the temperature of the external space R1, the estimation model is a statistical regression model for estimating the temperature of the external space R1.

The estimation unit 23 is a unit that estimates the thermal index in the external space R1 based on the temperature of the internal space R2, the motion information of the housing 16, and the light quantity received by the housing 16. The estimation unit 23 estimates the temperature of the external space R1 as the thermal index in the external space R1. In the present embodiment, the estimation unit 23 estimates the temperature of the external space R1 using the above-described estimation model.

The output unit 24 is a unit that outputs the estimation result. In the present embodiment, the output unit 24 outputs the temperature of the external space R1 estimated by the estimation unit 23 as the estimation result. For example, the output unit 24 displays the estimation result on the output device (display) of the estimation device 20. The output unit 24 may output the various kinds of estimation time-series data input to the estimation model, along with the estimation result.

An example of a method of generating the estimation model will be described. First, after the measurement device 10 is attached to human or a robot arm imitating an arm of human, the measurement and the detection by the temperature measurement unit 12, the detection unit 13, and the light quantity measurement unit 14 are continuously performed, and values thereof are stored in a memory (not shown) in the measurement device 10. Simultaneously, the temperature of the external space R1 is continuously measured and recorded by another measurement device having a temperature measuring function. In the other measurement device, for example, the temperature sensor is directly exposed to the external space R1. The other measurement device may be placed in the external space R1, or may be attached to human or the robot arm imitating the arm of human similarly to the measurement device 10.

Next, data during a predetermined period is extracted from each time-series data of the temperature of the internal space R2, the motion information, and the light quantity stored in the memory. Next, data of the temperature of the external space R1 at a certain time during the predetermined period is extracted from the time-series data of the temperature of the external space R1. The time is, for example, the latest time during the predetermined period. Then, a combination of the extracted time-series data of the temperature of the internal space R2, the motion information, and the light quantity and the data of the temperature of the external space R1 is generated. The combination of the generated data can be training data for learning the estimation model. The estimation model is generated by executing machine learning based on the training data generated in this manner. As the statistical regression model, for example, a recurrent neural network (RNN) is used.

Another example of a method of generating the estimation model will be described. First, a multi-physics simulation for heat transfer between the internal space R2 and the external space R1 in the measurement device 10 and a temperature change in the internal space R2 due to the motion information of the housing 16 and the light quantity received by the housing 16 may be performed. Based on the simulation result, the time-series data of the calculated values of the temperature of the internal space R2, the motion information, and the light quantity is generated. Time-series data of the corresponding temperature of the external space R1 is also calculated.

Next, similarly to the method described above, the data during the predetermined period is extracted from the generated time-series data of the temperature of the internal space R2, the motion information, and the light quantity, and the data at the certain time is extracted from the time-series data of the temperature of the external space R1. Then, the training data including the combination of the extracted time-series data of the temperature of the internal space R2, the motion information, and the light quantity and the data of the temperature of the external space R1 is generated. The estimation model may be generated by executing machine learning based on the training data generated in this manner. According to this method, it is possible to generate a large amount of the training data without performing actual measurement. Note that both the training data generated by the actual measurement and the training data generated by the simulation described above may be used for machine learning.

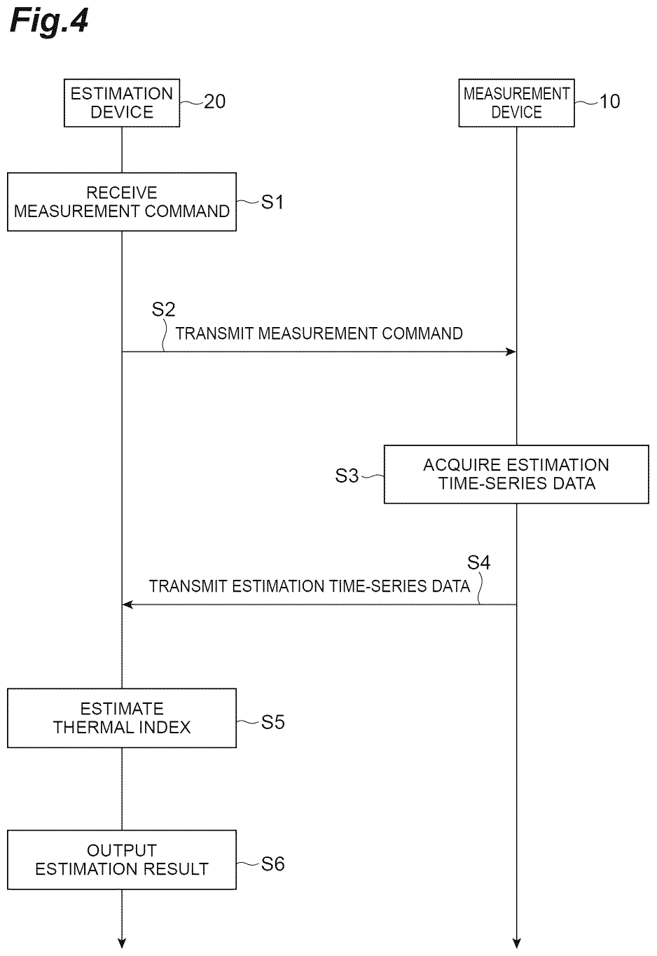

Next, a thermal index estimation method performed by the thermal index estimating system 1 will be described with reference to FIG. 4. FIG. 4 is a sequence diagram showing a series of operations performed by the thermal index estimating system shown in FIG. 1. A series of operations shown in FIG. 4 is started, for example, by a user operating the input device of the estimation device 20 and inputting the measurement command to the estimation device 20. In the present embodiment, the measurement command includes a start time and an end time. Note that, in the measurement device 10, the temperature measurement unit 12 continuously measures the temperature of the internal space R2, the detection unit 13 continuously detects the motion information of the housing 16, and the light quantity measurement unit 14 continuously measures the light quantity received by the housing 16.

As shown in FIG. 4, first, the estimation device 20 receives the measurement command input by the user (step S1). Subsequently, the communication unit 21 transmits the measurement command to the measurement device 10 (step S2).

Subsequently, upon receiving the measurement command from the estimation device 20, the control unit 15 of the measurement device acquires the estimation time-series data (step S3). In step S3, the control unit 15 samples the temperature of the internal space R2 measured by the temperature measurement unit 12, the motion information detected by the detection unit 13, and the light quantity measured by the light quantity measurement unit 14 in a measurement period from the start time to the end time, and stores them in the memory (not shown). As a result, the control unit 15 acquires the estimation time-series data of the temperature of the internal space R2, the estimation time-series data of the motion information, and the estimation time-series data of the light quantity.

Subsequently, the control unit 15 transmits each piece of the estimation time-series data to the estimation device 20 (step S4). Then, upon receiving each piece of the estimation time-series data from the measurement device 10, the communication unit 21 of the estimation device 20 outputs the received each piece of the estimation time-series data to the estimation unit 23. At this time, the communication unit 21 may store each piece of the received estimation time-series data in the storage unit 22.

Subsequently, the estimation unit 23 estimates the thermal index in the external space R1 based on the temperature of the internal space R2, the motion information of the housing 16, and the light quantity received by the housing 16 (step S5). In the present embodiment, the temperature of the external space R1 is estimated as the thermal index in the external space R1. In step S5, in order to estimate the temperature of the external space R1 at a certain time, the estimation unit 23 extracts data during a predetermined period from the estimation time-series data of the temperature of the internal space R2, the estimation time-series data of the motion information of the housing 16, and the estimation time-series data of the light quantity received by the housing 16. Then, the estimation unit 23 inputs the extracted estimation time-series data during the predetermined period to the estimation model, and calculates an estimated value of the temperature of the external space R1 at the certain time. The predetermined period is set based on, for example, the time until both the motion information of the housing 16 and the light quantity received by the housing 16 are reflected in the temperature measured by the temperature measurement unit 12. The predetermined period may be several tens of seconds from several ten seconds before the certain time to the certain time, or may be several minutes from several minutes before the certain time to the certain time. By performing this processing on each of the data at all times, the time-series data of an estimated value of the temperature of the external space R1 is obtained as an output.

That is, in step S5, the estimation unit 23 estimates the temperature of the external space R1 using the estimation model, which is the statistical regression model for estimating the thermal index (temperature) of the external space R1. The estimation unit 23 outputs the time-series data of the estimated temperature (the estimated value) of the external space R1 to the storage unit 22 and the output unit 24 as the estimation result.

Subsequently, the output unit 24 outputs the estimation result (step S6). In step S6, upon receiving the estimation result from the estimation unit 23, the output unit 24 displays the estimation result on the output device (display) of the estimation device 20. The output unit 24 may display each piece of the estimation time-series data input to the estimation model to the display (display device), along with the estimation result.

As described above, in the thermal index estimating system 1, the thermal index (temperature) in the external space R1 is estimated based on the temperature of the internal space R2, the motion information indicating the motion of the housing 16, and the light quantity received by the housing 16. In estimating the thermal index (temperature) in the external space R1 using the temperature of the internal space R2, it is necessary to consider a temperature difference between the internal space R2 and the external space R1. The temperature difference may depend on an amount of air ventilated between the internal space R2 and the external space R1 via the vent hole 16e and the light quantity received by the housing 16. Furthermore, the amount of ventilated air may depend on the motion of the housing 16. For example, when the motion of the housing 16 is intense, the amount of ventilated air can increase.

In the thermal index estimating system 1, when the thermal index (temperature) in the external space R1 is estimated, the motion information of the housing 16 and the light quantity received by the housing 16, which may affect the temperature difference between the internal space R2 and the external space R1, are considered. Therefore, the thermal index (temperature) in the external space R1 can be estimated without providing a member functioning as a heat conduction path connecting the internal space R2 and the external space R1. As a result, the thermal index (temperature) in the external space R1 can be estimated with a simple structure.

The estimation unit 23 estimates a thermal index (temperature) in the external space R1 based on the time-series data of the temperature of the internal space R2, the time-series data of the motion information of the housing 16, and the time-series data of the light quantity received by the housing 16. Although the motion information of the housing 16 and the light quantity received by the housing 16 may affect the temperature difference between the internal space R2 and the external space R1, the motion of the housing 16 and the light quantity received by the housing 16 are not immediately reflected in the temperature difference. Therefore, by using the time-series data in the certain period of the temperature of the internal space R2, the motion information, and the light quantity, changes in the temperature of the internal space R2, the motion information, and the light quantity in the certain period are considered. Therefore, an estimation accuracy of the thermal index (temperature) in the external space R1 can be improved.

The estimation unit 23 estimates the temperature of the external space R1 using the estimation model, which is the statistical regression model configured to receive the time-series data of the temperature of the internal space R2, the time-series data of the motion information of the housing 16, and the time-series data of the light quantity received by the housing 16 as input, and outputs the time-series data of the temperature of the external space R1. Therefore, the estimation accuracy of the temperature of the external space R1 can be improved by sufficiently learning the estimation model.

The detection unit 13 includes the inertial sensor. In order to detect the motion information of the housing 16, it is considered that the detection unit 13 includes a wind speed sensor or a speed sensor. Since sizes of these sensors are larger than the inertial sensor, however, there is a possibility that the housing 16 becomes larger. In the thermal index estimating system 1, since the detection unit 13 includes the inertial sensor, the detection unit 13 can be easily disposed in the housing 16.

The motion information detected by the detection unit 13 includes the acceleration of the housing 16. Since the acceleration of the housing 16 remarkably reflects the motion of the housing 16, the estimation accuracy of the thermal index (temperature) in the external space R1 can be improved.

The motion information includes the direction of the acceleration of the housing 16. The amount of air ventilated between the internal space R2 and the external space R1 via the vent hole 16e can further depend on the motion of the housing 16 in the direction in which the vent hole 16e opens. In the configuration in which the motion information includes the direction of the acceleration of the housing 16, the motion of the housing 16 in the direction in which the vent hole 16e opens can be derived based on the direction of the acceleration. Therefore, by adopting the direction of the acceleration of the housing 16 as the motion information, the estimation accuracy of the thermal index (temperature) in the external space R1 can be further improved.

The filter 17 is provided in the vent hole 16e. Therefore, it is possible to ensure air permeability in the vent hole and prevent the foreign matter from entering the housing 16.

The temperature measurement unit 12, the detection unit 13, and the light quantity measurement unit 14 are disposed in the housing 16. Therefore, since the temperature measurement unit 12, the detection unit 13, and the light quantity measurement unit 14 are housed in the housing 16, the thermal index (temperature) in the external space R1 can be estimated with a simpler structure than a configuration in which the detection unit 13 and the light quantity measurement unit 14 are disposed in a housing different from the housing 16.

The window 18 includes a concave lens. Therefore, the light quantity measurement unit 14 can receive light incident from a wider angle range. Thus, a size of the window 18 can be reduced. The smaller the size of the window 18, the smaller the total quantity of light incident on the internal space R2. Therefore, in the configuration in which the size of the window 18 is reduced, it is possible to avoid an increase in a temperature of the circuit board 11.

The resist is formed on the surface of the circuit board 11, and silk printing is applied to the surface of the circuit board 11. Therefore, a reflectance of the circuit board 11 can be increased, and it is possible to avoid the increase in the temperature of the circuit board 11 due to solar radiation.

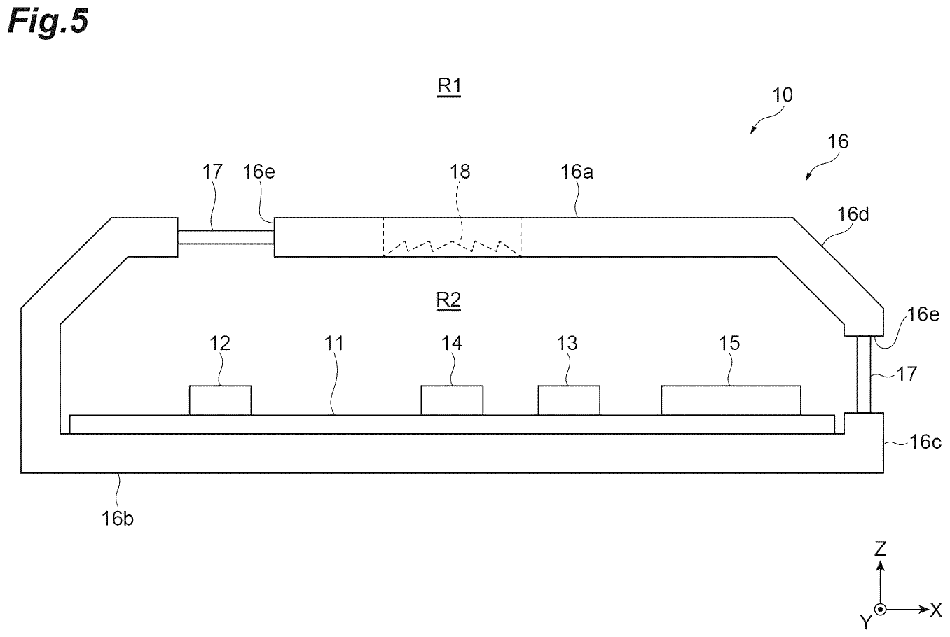

Next, a configuration of a modification of the thermal index estimating system 1 according to the present embodiment will be described with reference to FIG. 5. FIG. 5 is a diagram showing a modification of the measurement device shown in FIG. 2. Also in FIG. 5, hatching is omitted to clearly show each portion as in FIG. 3. The measurement device 10 according to the present modification is mainly different from the measurement device 10 according to the above embodiment in the position of the vent hole 16e.

As shown in FIG. 5, in the present modification, the two vent holes 16e are opened in directions different from each other. Specifically, one vent hole 16e of the two vent holes 16e is provided with the upper wall portion 16a and penetrates the upper wall portion 16a in the up-down direction. The other vent hole 16e of the two vent holes 16e is provided with the side wall portion 16c and penetrates the side wall portion 16c in the left-right direction. Note that the two vent holes 16e may be provided with any portion of the upper wall portion 16a, the bottom wall portion 16b, the side wall portion 16c, and the inclined wall portion 16d as long as the two vent holes 16e are opened in directions different from each other.

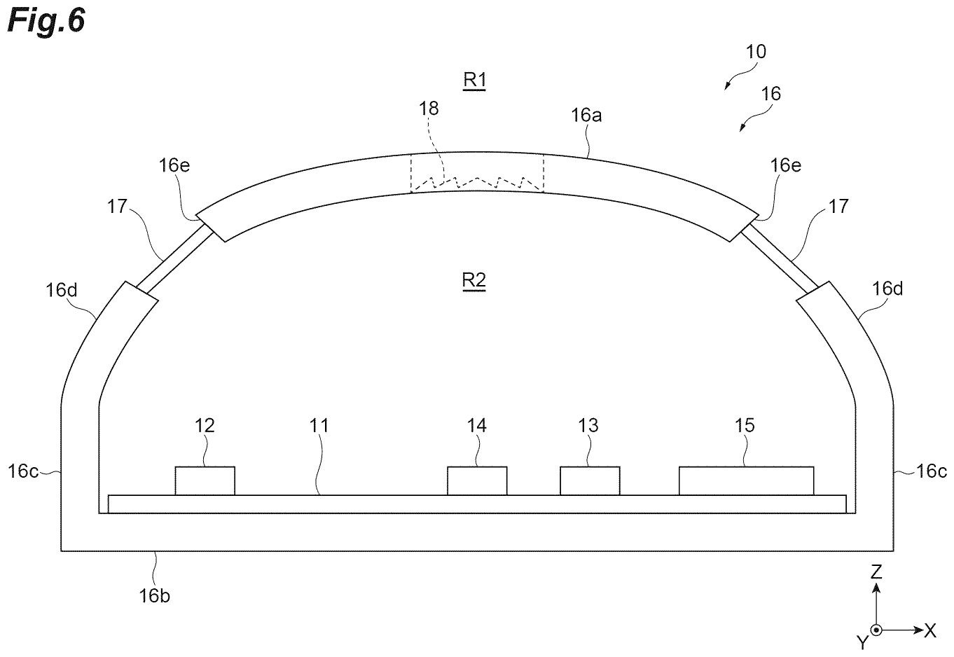

Next, a configuration of another modification of the thermal index estimating system 1 according to the present embodiment will be described with reference to FIG. 6. FIG. 6 is a diagram showing another modification of the measurement device shown in FIG. 2. Also in FIG. 6, hatching is omitted to clearly show each portion as in FIGS. 3 and 5. The measurement device 10 according to the present modification is mainly different from the measurement device 10 according to the above embodiment in the shape of the housing 16 and the position of the vent hole 16e.

As shown in FIG. 6, in the present modification, the upper wall portion 16a and the inclined wall portion 16d have curvatures. That is, in the present modification, the upper wall portion 16a and the inclined wall portion 16d have curved shapes to protrude toward the external space R1. As a result, the housing 16 has a rounded shape as a whole.

Also in the present modification, the two vent holes 16e are opened in directions different from each other. Specifically, the two vent holes 16e are provided with the upper wall portion 16a. The two vent holes 16e are provided at different positions in the upper wall portion 16a, and penetrate the upper wall portion 16a in a direction inclined in the up-down direction. Note that, also in the present modification, the two vent holes 16e may be provided with any portion of the upper wall portion 16a, the bottom wall portion 16b, the side wall portion 16c, and the inclined wall portion 16d as long as the two vent holes 16e are opened in directions different from each other.

When the thermal index (temperature) in the external space R1 is estimated, an estimation error may occur. The larger the temperature difference between the internal space R2 of the housing 16 and the external space R1 of the housing 16, the larger the estimation error. In each of the modifications described above, the two vent holes 16e are opened in directions different from each other. Therefore, the air is efficiently circulated between the internal space R2 and the external space R1, so that the temperature difference between the internal space R2 and the external space R1 can be reduced. As a result, the estimation accuracy of the thermal index (temperature) in the external space R1 can be improved.

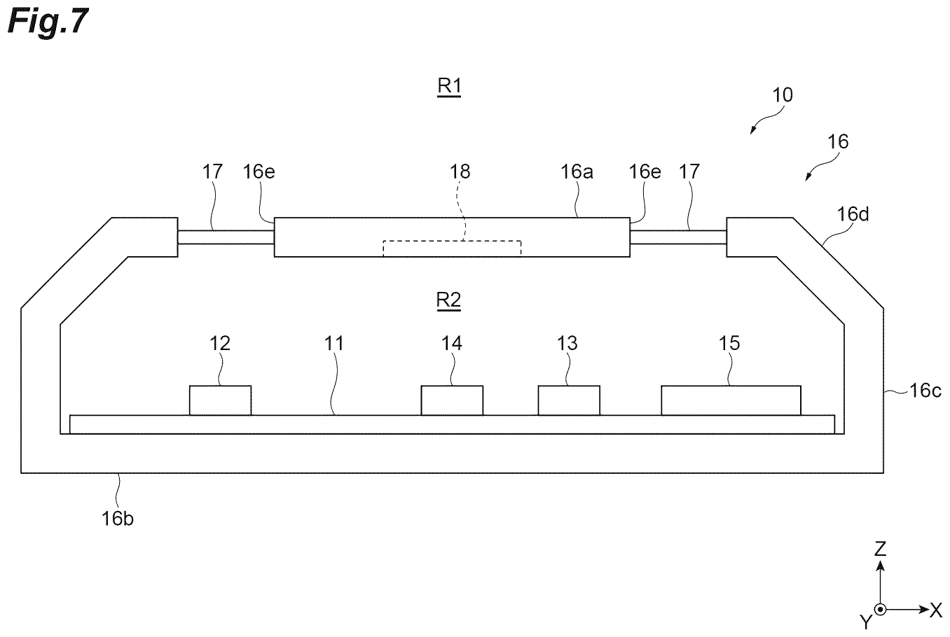

Next, a configuration of still another modification of the thermal index estimating system 1 according to the present embodiment will be described with reference to FIG. 7. FIG. 7 is a diagram showing still another modification of the measurement device shown in FIG. 2. Also in FIG. 7, hatching is omitted to clearly show each portion as in FIGS. 3, 5, and 6. The measurement device 10 according to the present modification is mainly different from the measurement device 10 according to the above embodiment in the method of forming the window 18.

In the present modification, the window 18 is formed by thinning the housing 16. As described above, the housing 16 is made of plastic resin and metal. In the present modification, the window 18 is formed by thinning plastic resin constituting the housing 16, and the housing 16 and the window 18 are integrally formed.

In the present modification, since the housing 16 and the window 18 can be integrally formed, the thermal index in the external space R1 can be estimated with a simpler structure. Furthermore, in the present modification, even if a material constituting the housing 16 and the window 18 is an opaque material, the light received by the housing 16 is transmitted through the window 18. Therefore, even if the material constituting the housing 16 and the window 18 is the opaque material, the light quantity measurement unit 14 can measure the light quantity received by the housing 16.

The present disclosure is not necessarily limited to the above-described embodiments and modifications, and various modifications can be made without departing from the gist of the present disclosure.

In the above-described embodiment and modification, the temperature measurement unit 12, the detection unit 13, and the light quantity measurement unit 14 are disposed in the same housing 16. However, positions of the temperature measurement unit 12, the detection unit 13, and the light quantity measurement unit 14 is not limited to the above-described disposition. For example, the temperature measurement unit 12 and the light quantity measurement unit 14 may be disposed in the housing 16, and the detection unit 13 may be disposed in another housing different from the housing 16. The temperature measurement unit 12 and the detection unit 13 may be disposed in the housing 16, and the light quantity measurement unit 14 may be disposed in another housing different from the housing 16. Alternatively, the temperature measurement unit 12 may be disposed in the housing 16, and the detection unit 13 and the light quantity measurement unit 14 may be disposed in a housing different from the housing 16. In a configuration in which the detection unit 13 is disposed in a housing different from the housing 16, the different housing is mounted at a position close to the housing 16. For example, in a case where the housing 16 is worn on a human arm, the different housing is also worn on the arm to which the housing 16 is worn. As a result, even if the detection unit 13 is disposed in a housing different from the housing 16, the motion information detected by the detection unit 13 can be regarded as the motion information of the housing 16.

In the above-described embodiment and modification, the number of the vent holes 16e is “2”, but may be “1” or “3” or more. In a configuration in which the number of the vent holes 16e is “3” or more, at least two vent holes 16e of three or more vent holes 16e may be opened in directions different from each other.

In the above-described embodiment and modification, the filter 17 is provided in the vent hole 16e to close the vent hole 16e, but the filter 17 may not be provided in the vent hole 16e. That is, the measurement device 10 may not include the filter 17.

In the above-described embodiment and modification, the motion information of the housing 16 includes the acceleration of the housing 16 and the direction of the acceleration. However, parameters included in the motion information of the housing 16 are not limited to the above-described parameters (the acceleration of the housing 16 and the direction of the acceleration). For example, the motion information of the housing 16 may include velocity of the housing 16 and the direction of the velocity instead of the acceleration of the housing 16 and the direction of the acceleration. In this configuration, the detection unit 13 may include a velocity sensor. Alternatively, the motion information of the housing 16 may include a wind velocity of the air ventilated between the internal space R2 and the external space R1 via the vent hole 16e and the direction of the wind velocity, instead of the acceleration of the housing 16 and the direction of the acceleration. In this case, the detection unit 13 may include a wind velocity sensor.

In the above-described embodiment and modification, the estimation unit 23 estimates the temperature of the external space R1 based on the temperature of the internal space R2, the motion information of the housing 16, and the light quantity received by the housing 16. However, the parameters used for estimating the temperature of the external space R1 is not limited to the above-described parameters (the temperature of the internal space R2, the motion information of the housing 16, and the light quantity received by the housing 16). In a case where a human possesses the measurement device 10, the estimation unit 23 may estimate the temperature of the external space R1 based on a type of activity performed by the human in addition to the above-described parameters. In this case, the type of the activity may be input to the estimation device 20 by the user via the input device. Alternatively, the estimation unit 23 may determine the type of activity based on the motion information of the housing 16 detected by the detection unit 13.

The “type of activity” indicates a state of action of the human possessing the measurement device 10 at the time of measuring various parameters. Examples of the type of activity include a state of walking, a state of running, and a state of riding on a bicycle. In a configuration in which the estimation unit 23 estimates the temperature of the external space R1 based on the temperature of the internal space R2, the motion information of the housing 16, the light quantity received by the housing 16, and the type of activity, the storage unit 22 may store a plurality of estimation models according to the type of activity. The estimation unit 23 may estimate the temperature of the external space R1 using the estimation model corresponding to the type of activity.

In the embodiment and the modification described above, the estimation unit 23 estimates the temperature of the external space R1 using the estimation model that receives the time-series data of the temperature of the internal space R2, the time-series data of the motion information of the housing 16, and the time-series data of the light quantity received by the housing 16 as input, and outputs the time-series data of the temperature of the external space R1. However, the time-series data is not necessarily used for the input of the estimation model.

For example, the estimation unit 23 may estimate the temperature of the external space R1 using an estimation model that receives the temperature of the internal space R2, the motion information of the housing 16, and the light quantity received by the housing 16 at a certain time (measurement time) as input, and outputs the temperature of the external space R1. The control unit 15 may sample the temperature of the internal space R2 measured by the temperature measurement unit 12, the motion information detected by the detection unit 13, and the light quantity measured by the light quantity measurement unit 14 at each measurement time, and store them in the memory (not shown). The estimation model may be generated by executing machine learning based on ground truth data including a combination of the temperature of the internal space R2, the motion information of the housing 16, and the light quantity received by the housing 16 at each measurement time, and the actual measurement value of the temperature of the external space R1 at the measurement time. Even in this configuration, the estimation accuracy of the thermal index (temperature) in the external space R1 can be improved by sufficiently learning the estimation model.

In the embodiment and the modification described above, the estimation unit 23 estimates the temperature in the external space R1 using the RNN, which is a kind of statistical regression model, but the method of estimating the thermal index (temperature) is not limited to the method using the RNN. For example, the estimation unit 23 may estimate the temperature of the external space R1 using other statistical regression models. In this configuration, the other statistical regression models is generated by executing regression analysis or parameter fitting using the temperature of the internal space R2, the motion information of the housing 16, and the light quantity received by the housing 16, or time-series data thereof as explanatory variables and using the temperature of the external space R1 or the time-series data thereof as an objective variable. Examples of the other statistical regression models include a linear model, a generalized linear model, a vector autoregressive model, a neural network (including a neural network without recursive structure such as the RNN), a support vector regression model, a random forest, and XGboost.

Alternatively, the estimation unit 23 may calculate the temperature difference between the temperature of the internal space R2 and the temperature of the external space R1 by physically modeling a phenomenon related to the temperature in the measurement device 10 without using the statistical regression model, and estimate the temperature of the external space R1 based on the temperature of the internal space R2 and the temperature difference. Here, in order to physically model the phenomenon related to the temperature, for example, a thermal equivalent circuit may be used. The thermal equivalent circuit is a circuit in which heat transfer between the internal space R2 and the external space R1 in the measurement device 10 is modeled with an electric circuit. Among parameters of elements constituting the heat equivalent circuit, a parameter whose value changes responding to the motion of the housing 16 and the light quantity received by the housing 16 may be changed responding to the motion information of the housing 16 and the light quantity received by the housing 16.

The measurement device 10 may have the function (the storage unit 22, the estimation unit 23, and the output unit 24) of the estimation device 20. For example, the control unit 15 may function as the storage unit 22, the estimation unit 23, and the output unit 24. That is, the control unit 15 may estimate the thermal index (temperature) in the external space R1 based on the temperature of the internal space R2, the motion information of the housing 16, and the light quantity received by the housing 16, and output the estimation result. Furthermore, the measurement device 10 may physically include an input device that receives an input from the user, and may physically include a display (display device) that displays the estimation result.

In the above-described embodiment and modification, the estimation unit 23 estimates the temperature of the external space R1 as the thermal index, but the thermal index to be estimated may be another index such as wet-bulb globe temperature, UTCI (Universal Thermal Climate Index), predicted mean vote, effective temperature, or standard effective temperature. In this configuration, since values of humidity and water vapor pressure also contribute to the thermal index, the estimation unit 23 may estimate the thermal index based on humidity and air pressure of the internal space R2 in addition to the temperature of the internal space R2, the motion information of the housing 16, and the light quantity received by the housing 16. In this configuration, the measurement device 10 may further include a humidity sensor and an air pressure sensor.

Furthermore, in a case where a human possesses the measurement device 10, a clothing amount and a metabolic rate of the human also contribute to the thermal index. The metabolic rate varies depending on age and sex. For example, there is a tendency that the older the age, the smaller the metabolic rate, and the metabolic rate is lower in women than in men. Therefore, the estimation unit 23 may estimate the thermal index on the based on at least one of the clothing amount, the age, and the sex of the human who possesses the measurement device 10 in addition to the various parameters described above. In this configuration, the clothing amount, the age, and the sex may be input to the estimation device 20 by the user in advance via the input device and stored in the storage unit 22. Note that in the configuration of estimating the thermal index other than the temperature of the external space R1, the temperature of the external space R1 in the training data for learning the estimation model is replaced with a measured value or a simulation value of the thermal index to be estimated, and the learning is performed.

Data (features) obtained by performing preprocessing on the various parameters acquired by the measurement device 10 may be input to the estimation model. For example, in the configuration in which the motion information of the housing 16 includes the acceleration of the housing 16, a predetermined index may be calculated for each certain section by performing the preprocessing on the time-series data of the acceleration, and the thermal index may be estimated using the index instead of the acceleration of the housing 16. The preprocessing may be performed by the control unit 15.

Examples of the index include Zero Crossing (ZC), Time Above the Threshold (TAT), Proportional Integration (PI), and the like. ZC is an index indicating the number of times the acceleration value has exceeded a predetermined value in the time-series data. TAT is an index indicating a total time in which a value of the acceleration indicates a predetermined threshold or more in the time-series data. PI is an index indicating an area of a region surrounded by a graph of the acceleration time-series data of the housing 16 and a graph in which a value of the acceleration is a constant value when a two-dimensional coordinate system in which the vertical axis is the value of the acceleration and the horizontal axis is time is considered. Any of the above indices may be used as an index indicating the degree of motion of the housing 16.

In a configuration in which the thermal index of the external space R1 is estimated using the index instead of the acceleration of the housing 16, the memory (not shown) in the measurement device 10 stores time-series data of the index as the estimation time-series data of the motion information of the housing 16. Since these indices are represented by one numerical value for a certain section, data capacity is small as compared with the time-series data of the acceleration of the housing 16. Therefore, storage capacity of the memory in the measurement device 10 can be saved. However, the preprocessing and the calculation of the index are not necessarily performed by the control unit 15, and may be performed in the estimation device 20.

### REFERENCE SIGNS LIST

1 . . . thermal index estimating system, 12 . . . Temperature measurement unit, 13 . . . Detection unit, 14 . . . . Light quantity measurement unit, 16 . . . . Housing, 16e . . . . Vent hole, 17 . . . . Filter, 18 . . . . Window, 23 . . . . Estimation unit, R1 . . . . External space, R2 . . . . Internal space

1. A thermal index estimating system comprising:
a housing defining an internal space, the housing being provided with a vent hole communicating between the internal space and an external space of the housing;
a temperature measurement unit disposed in the housing and configured to measure a temperature of the internal space;
a detection unit configured to detect motion information indicating a motion of the housing;
a light quantity measurement unit configured to measure a light quantity received by the housing; and
an estimation unit configured to estimate a thermal index in the external space based on the temperature of the internal space, the motion information, and the light quantity.

2. The thermal index estimating system according to claim 1, wherein the estimation unit estimates the thermal index based on time-series data of the temperature of the internal space, time-series data of the motion information, and time-series data of the light quantity.

3. The thermal index estimating system according to claim 1, wherein the estimation unit estimates the thermal index using a statistical regression model configured to receive the temperature of the internal space, the motion information, and the light quantity as input and output the thermal index.

4. The thermal index estimating system according to claim 1, wherein
the detection unit includes an inertial sensor, and
the motion information includes acceleration of the housing.

5. The thermal index estimating system according to claim 4, wherein the motion information further includes a direction of the acceleration of the housing.

6. The thermal index estimating system according to claim 1, further comprising a filter provided in the vent hole and configured to remove a foreign matter.

7. The thermal index estimating system according to claim 1, wherein
the housing is provided with another vent hole, and
the vent hole and the another vent hole are opened in directions different from each other.

8. The thermal index estimating system according to claim 1, further comprising a window provided with the housing and configured to transmit light from the external space to the internal space, wherein
the light quantity measurement unit is disposed in the housing, and
the window is disposed at a position overlapping the light quantity measurement unit in a plan view.

9. The thermal index estimating system according to claim 8, wherein the window includes a concave lens.

10. The thermal index estimating system according to claim 8, wherein the window is formed by thinning the housing.
